(19) United States
(12) Patent Application Publication
(10) Pub. No.: US 2016/0364667 A1
(43) Pub. Date: Dec. 15, 2016

(54) PROVIDING DYNAMICALLY RESPONSIVE AVAILABILITY VIEW

(71) Applicant: MICROSOFT TECHNOLOGY LICENSING, LLC, Redmond, WA (US)

(72) Inventors: Lee Mark Macatangay, Bothell, WA (US); Mario Tayah, Redmond, WA (US)

(21) Appl. No.: 14/880,297

(22) Filed: Oct. 12, 2015

Related U.S. Application Data
(60) Provisional application No. 62/175,993, filed on Jun. 15, 2015.

(51) Int. Cl. G06Q 10/06

(52) U.S. Cl. CPC G06Q 10/06313

(57) ABSTRACT

A dynamically responsive availability view is provided. An application, such as an availability service, manages tasks, resources, and a timeline associated with a project. In response to a request by a client application or an automated scheme, availability information associated with the resources is retrieved from a project data store. An availability model is generated based on the availability information and the resources. The availability model includes a chart of availability status plotting a cross section of a collection of the resources and recurring time periods of a timeline of the availability information. The availability model is provided to a client application to prompt the client application to render the availability model.

### CROSS-REFERENCE TO RELATED APPLICATIONS

This application claims the benefit under 35 U.S.C. §119(e) of U.S. Provisional Patent Application Ser. No. 62/175,993 filed on Jun. 15, 2015. The disclosure of the U.S. Provisional patent application is hereby incorporated by reference in its entirety.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications facilitate project management. Complicated project management applications hinder a project instead of streamlining the project.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a dynamically responsive availability view. In some examples, an availability service may manage tasks, resources, and a timeline associated with a project. Furthermore, availability information associated with the resources may be retrieved from a project data store. An availability model may be generated based on the availability information and the resources. The model may be provided to a client application to prompt the client application to render the availability model.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing a dynamically responsive availability view, according to embodiments;

FIG. 2 is a display diagram illustrating an example of providing an availability model, according to embodiments.

FIG. 3 is a display diagram illustrating an example of providing availability status details associated with the availability model, according to embodiments;

FIG. 4 is a display diagram illustrating an example of providing resource details associated with the availability model, according to embodiments:

FIG. 5 is a simplified networked environment, where a system according to embodiments may be implemented;

FIG. 6 is a block diagram of an example computing device, which may be used to provide a dynamically responsive availability view; and

FIG. 7 is a logic flow diagram illustrating a process for providing a dynamically responsive availability view, according to embodiments.

### DETAILED DESCRIPTION

As briefly described above, a dynamically responsive availability view may be provided by an availability service. The availability service may manage tasks, resources, and a timeline associated with a project. The resources may include people and consumables associated with the project. Next, in response to a request by a client application or an automated scheme, availability information associated with the resources may be retrieved from a project data store. The availability information may also be retrieved from a human resources data store, and/or an external data store, among others. The availability information may include availability status associated with each resource. The availability information may indicate a busy state or an available state across recurring time periods of the timeline spanning the availability information.

An availability model may be generated based on the availability information and the resources. The availability model may include a collection of the resources, a timeline of the availability information, and a chart of availability status. The collection of resources may include personnel or items that may be schedulable. The collection of resources may come from a project data store, a human resources data store (companies employees), a vendor (outsourced employees), or external sources like professional networks among others. The collection of resources may be any entity that is schedulable or has a state for time like a list of items or equipment being leased, services being activated for a certain duration, among others. The chart may also include information associated with the resources that are bound to a time period. For example, an airline business class seat for day 1 may be XXX, while for day 2 it may be YYY and for day 3 it may be ZZZ. This may include resource prices as well. Next, the availability model may be provided to a client application to prompt the client application to render the availability model. The client application may include a project user interface displayed on a client device. The availability model may be scalable to meet hardware and software constraints of the client device. For example, number of resources presented through the availability model may be constrained to match available screen size of the client device. The availability view representation may not always show collections of resource, time and availability information. The content represented may be just one or few resources, time and availability information as a response to varying form sizes of the availability view client (computing device like phone, tablets, wearables, etc.).

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide a dynamically responsive availability view. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

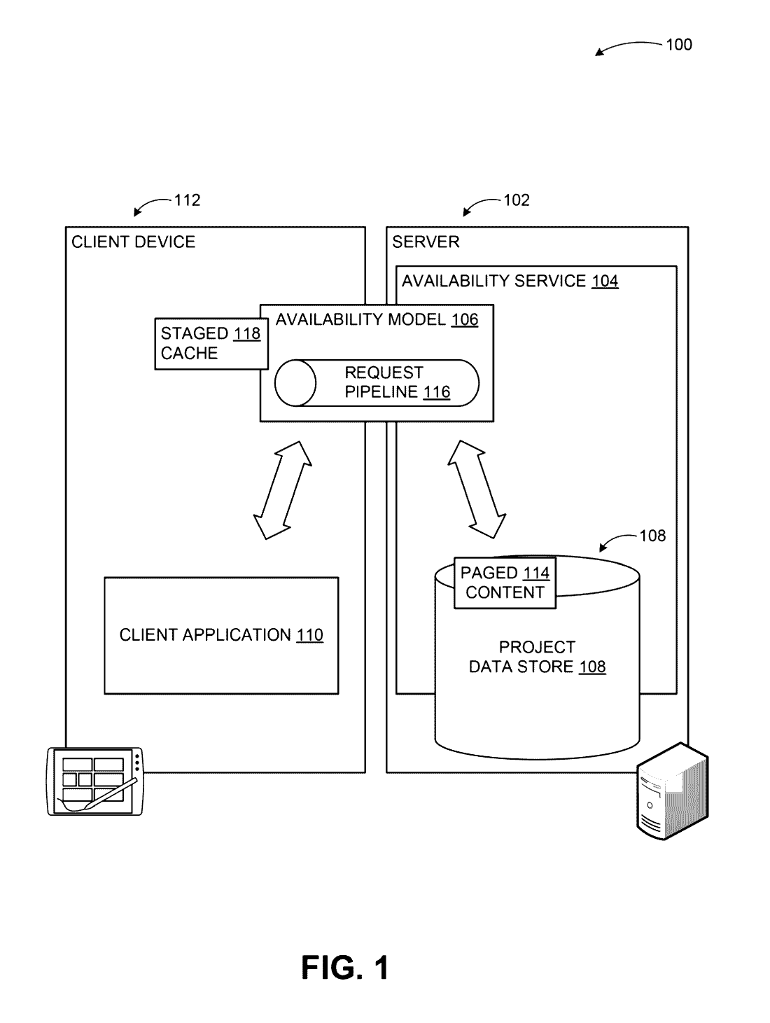

FIG. 1 is a conceptual diagram illustrating an example of providing a dynamically responsive availability view, according to embodiments.

In a diagram 100, a server 102 may execute an availability service 104. The server 102 may include a physical server, a server farm, a data warehouse, and/or a data center, among others.

The server 102 may execute the availability service 104, which may generate the availability model 106 in response to a request by a client application 110 (executed by the client device 112). Alternatively, the availability model 106 may be generated through an automated scheme in which the client application 110 is prompted to render the availability model 106 dynamically or based on a schedule.

The availability model 106 may include a representation of resources of a project and availability status associated with the resources. The resources may include people or consumables that may be schedulable and that may be associated with the project. The availability model 106 may also include detailed information associated with the availability status. For example, the detailed information may include the availability status across tasks of the project or other projects. The availability model 106 may also include resource details such as identification information, location, and/or available communication modalities, among others.

The availability model 106 may consist of a collection of resources, a timeline of the availability information, and a chart of availability status. The collection of the resources may be configured by a selection of the resources made by a stakeholder of the project. The timeline may include recurring time periods that start at a start date and end at an end date. By default, the timeline may have a duration of 6 weeks partitioned to 6 weekly time periods. The duration and recurrence of the time periods of the timeline may also be configured by the stakeholder.

The availability service 104 may retrieve paged content 114 of the availability information from the project data store 108. The availability information may also be retrieved from a human resources data store and/or an external data store, among others. A range of the paged content may be limited to the chart of the availability status presented by the client application 110. The paged content may also be limited to a subset of the collection of the resources as displayed by the client application 110. Additional paged content may be retrieved to update the availability model 106 as a project participant scrolls through the availability model 106. A size of the paged content may be constrained based on an available display area at the client device 112.

Requests associated with the availability model may be processed through a request pipeline 116. The request pipeline 116 may compare an incoming request to a recently processed request or to a presently processing request. When the request pipeline 116 detects the incoming request as identical to the recently processed request or the presently processing request, the request pipeline 116 may discard the incoming request. A response associated with the recently processed request or the presently processing request may be transmitted in response to the incoming request. For example, a new request for an availability status of a resource on a particular date may be compared to a previous request for an identical availability status. After detecting the identical requests, the new request may be discarded and a previous response to the previous request may be used to update the availability model 106 in response to the new request.

A staged cache may also be provided with the availability model 106. The staged cache may include saved calculated values and value aggregation associated with the collection of the resources, the timeline of the availability information, and the chart of the availability status within the availability model 106. The staged cache is provided to the client application 110 to prevent the client application from re-querying the calculated values and the value aggregations associated with the availability model 106. The staged cache may be refreshed based on requests to update the availability model 106 or updates detected in the project data store 108 associated with the availability model 106.

The server 102 may communicate with other devices such as the client device 112 through a network. The network may provide wired or wireless communications between nodes such as the server 102, or the client device 112, among others.

The project participant or a stakeholder may interact with client application or a user interface of the availability service 104 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 102, the client device 112, and/or the availability service, embodiments are not limited to these components or system configurations and can be implemented with other system configuration employing fewer or additional components.

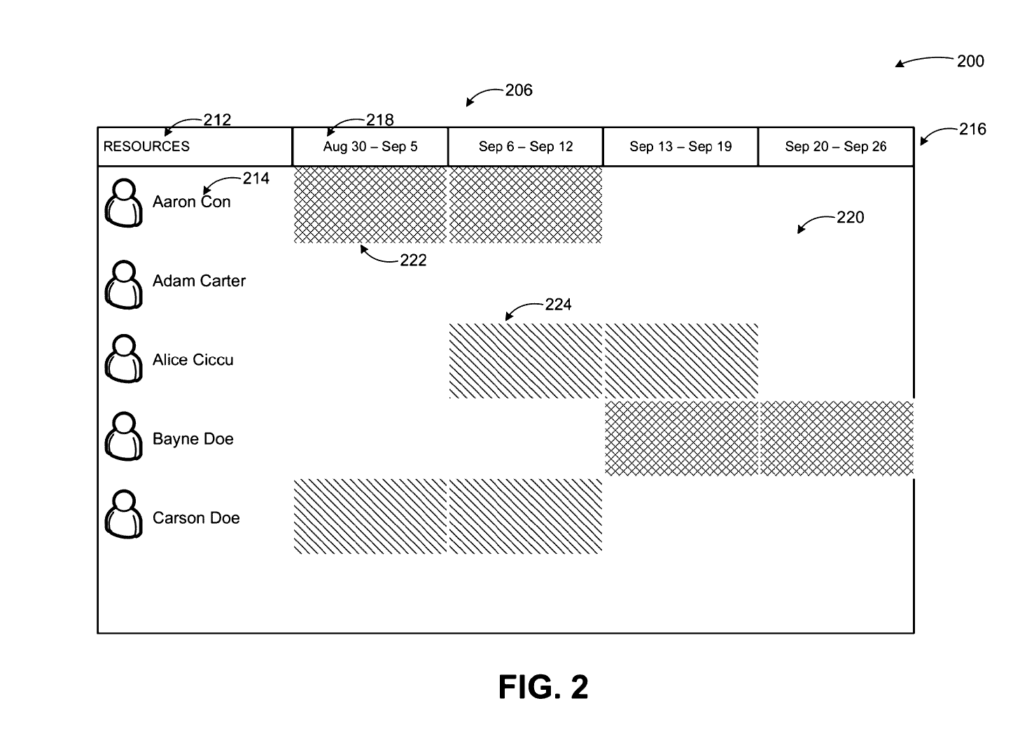

FIG. 2 is a display diagram illustrating an example of providing an availability model, according to embodiments.

In a diagram 200, an availability service may generate an availability model 206. The availability model 206 may include a collection 212 of resources, a timeline 216 of availability information, and a chart 220 of availability status.

The processes to generate the availability model 206 may be initiated in response to a request by an administrator such as a stakeholder of a project. The stakeholder may provide input to a client application (such as a project user interface) to display the availability model 206. The input may include configuration parameters such as a selection of the collection 212 of the resources and a duration of the timeline 216 and a recurring time period 218 of the timeline 216. The recurring time period 218 may be defined as an hour, a day, a week, a month, a year, and/or a combination of each, among others. A default timeline of the availability model 206 may be configured to present 6 weeks of availability information with a weekly recurring time period. Alternatively, the availability model 206 may also be generated through an automated process to prompt the client application to display the availability model 206 based on dynamic event or a schedule.

The chart 220 of the availability status may include rows of availability status associated with each resource. For example, a resource 214 may be presented with an availability status 222 in a time period 218 within the chart 220. The availability status may include variability such as a busy state or an available state. The variability in the availability status 222 and an availability status 224 may be presented with a highlighting scheme. For example, the availability status 222 may be presented with a highlighting scheme to show the availability status 222 within a busy state. Alternatively, the availability status 224 may be presented with another highlighting scheme to show the availability status 224 within an available state.

The timeline 216 may be provided with a horizontal scroll feature to provide an access to additional content (not currently displayed) within the availability model 206. Similarly, the collection 212 may be provided with a vertical scroll feature to provide access to additional content within the availability model 206 not currently displayed by the client application. Additionally, the chart 220 may be provided with a horizontal scroll feature and/or a vertical scroll feature to provide access to additional content within the availability model 206 not currently displayed by the client application. The additional content may be retrieved from the project data store as paged content in response to scroll actions to access the additional content. The paged content may be used to update the availability model 206, which may be provided to the client application for rendering.

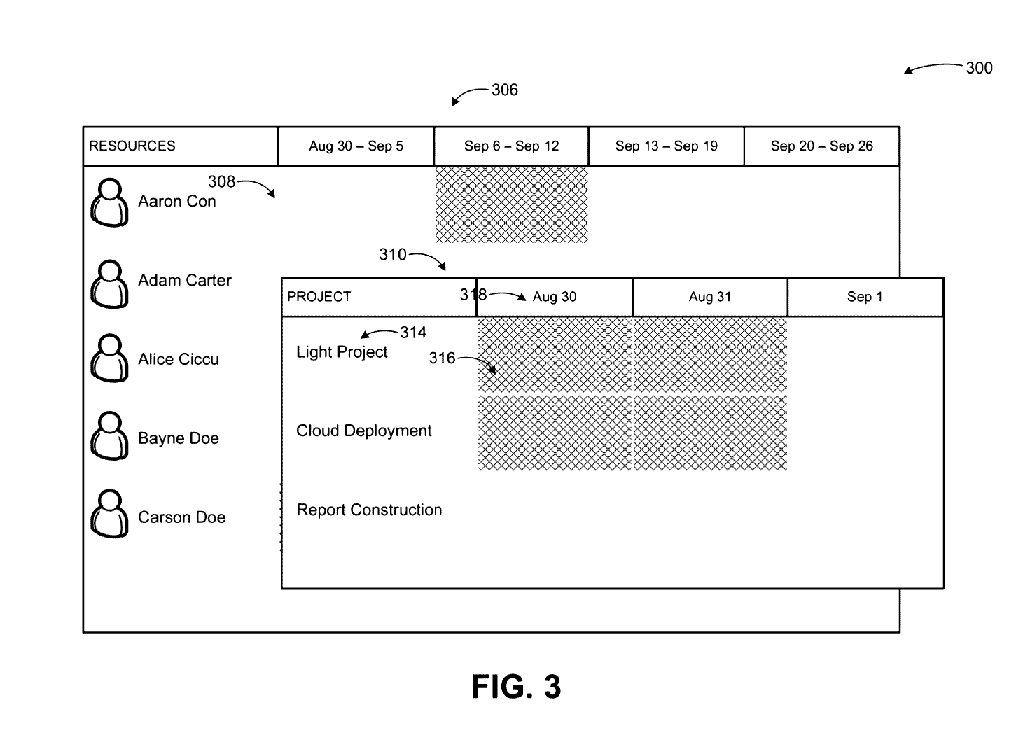

FIG. 3 is a display diagram illustrating an example of providing resource details associated with the availability model, according to embodiments.

In a diagram 300, an availability service may generate availability status details 310 based on a request. A client application may transmit the request to the availability service in response to a project participant selection of an availability status 308. In response, the availability service may retrieve the availability status details associated with the availability status 308 of a resource from a project data store.

The availability status details 310 may include a project name 314 (or a task name) and an associated availability status 316 within a timeline that is divided by a recurring time period 318. The recurring time period 318 may include an additional level of granularity compared to a recurring time period of the timeline presented on the availability model 306. For example, the recurring time period of the timeline on the availability model 306 may have a duration of a week. The recurring time period 318 presented on the availability status details may present a day slice of the week.

The availability status details 310 may also include project names (or task names) and associated availability status of the resource across a timeline that include the recurring time period 318. The availability status 316 may include a busy state, and/or an available state, among others. Additional information associated with the resource may also be included in the availability status details 310 such a location (not displayed) of the resource during a project, other projects, and/or a time period.

The availability status details 310 may be provided to the client application to prompt the client application to display the availability status details 310.

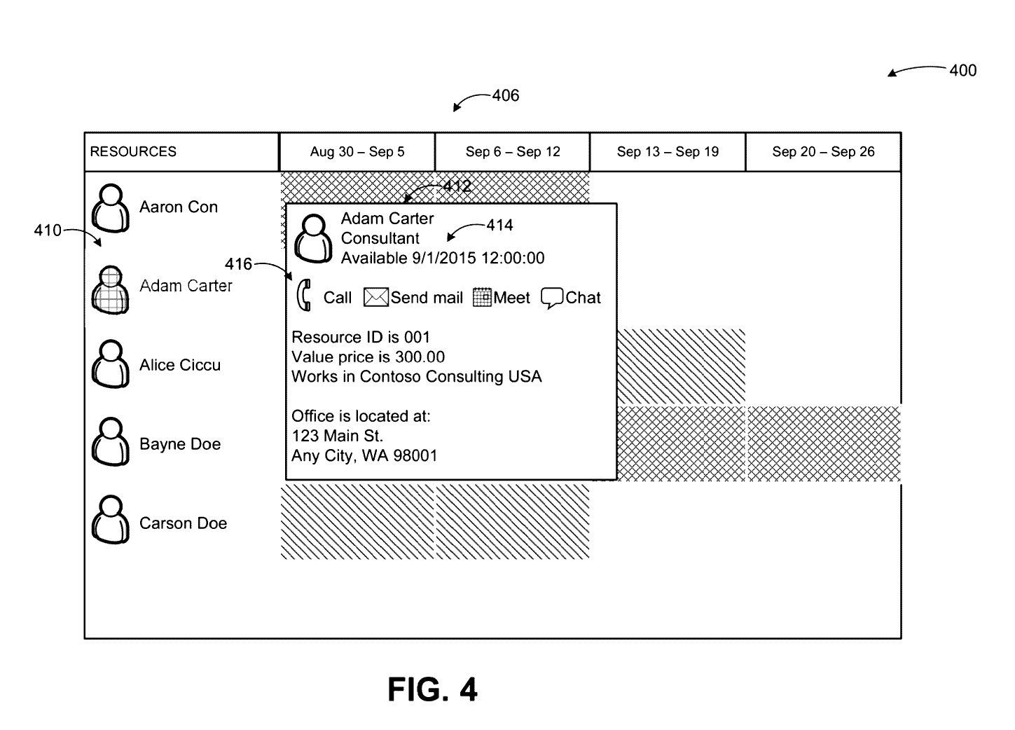

FIG. 4 is a display diagram illustrating an example of providing resource details associated with the availability model, according to embodiments.

In a diagram 400, an availability service may generate resource details 412 in response to a request by a client application. The client application may transmit the request in response to an action by a project participant on a resource 410 presented on the availability model 406.

The availability service may query a project data store to retrieve the resource details 412 associated with the resource 410. The resource details may include identification information 414 associated with the resource 410, communication modalities 416 associated with the resource 410, an identifier used to label the resource 410, a cost information associated with the resource 410, an organization associated with the resource 410, and/or a location of the resource 410, among others.

The communication modalities 416 to contact the resource 410 may be provided with actionable elements to initiate a communication application associated with the actionable elements. The actionable elements may be configured to execute operations to initiate the associated communication application to establish a communication with the resource, in response to an activation.

As discussed above, the service may be employed to perform operations associated with providing a dynamically responsive availability view. An increased user efficiency with the availability service may occur as a result of the availability model used to present availability status of a collection of resources across a timeline. Additionally, providing the availability model with a staged cache 118, with requests processed through a request pipeline 116, and paged content 114 used to generate and update the availability model 106 may reduce processor load, increase processing speed, conserve memory, and reduce network bandwidth usage.

Embodiments, as described herein, address a need that arises from a lack of efficiency between a stakeholder or a project participant interacting with the availability service 104 of the server 102. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing a dynamically responsive availability view may be implemented in configurations employing fewer or additional components in applications and user interfaces. Furthermore, the example schema and components shown in FIG. 1 through 4 and their subcomponents may be implemented in a similar manner with other values using the principles described herein.

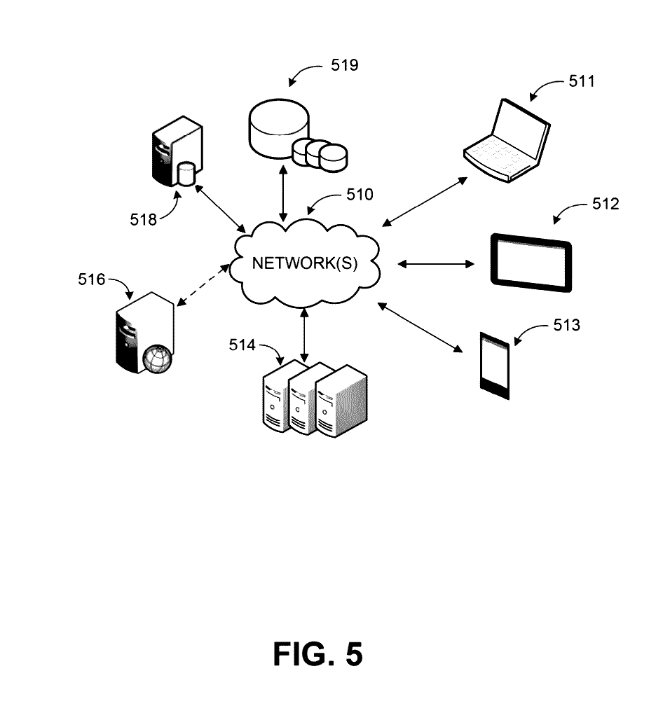

FIG. 5 is an example networked environment, where embodiments may be implemented. An availability service configured to provide a dynamically responsive availability view may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. An availability service may manage tasks, resources, and a timeline associated with a project. Availability information associated with the resources may be retrieved from a project data store to generate an availability model based on the availability information. The availability model may be provided to a client application to prompt the client application to render the availability model. The availability service may store data associated with availability status in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a dynamically responsive availability view. Furthermore, the networked environments discussed in FIG. 5 are for illustration purposes only. Embodiments are not limited to the example applications, modules, or processes.

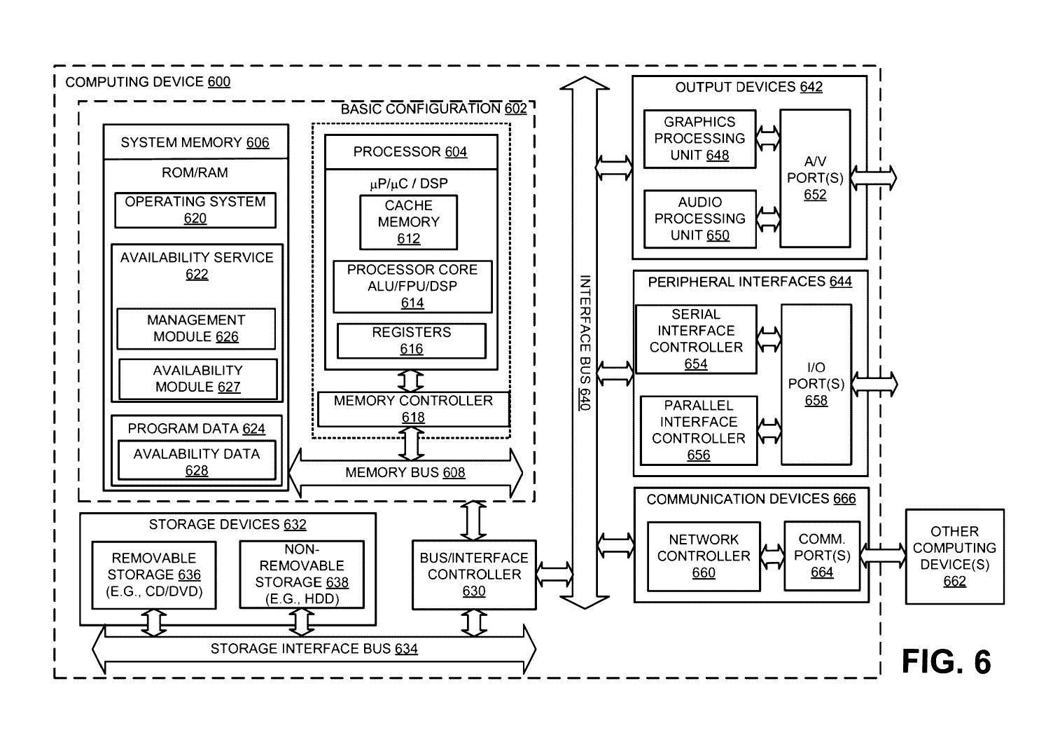

FIG. 6 is a block diagram of an example computing device, which may be used to provide a dynamically responsive availability view.

For example, computing device 600) may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, an availability service 622, and a program data 624. The availability service 622 may include components such as a management module 626 and an availability module 627. The management module 626 and the availability module 627 may execute the processes associated with the availability service 622. The management module 626 may manage tasks, resources, and a timeline associated with a project. The availability module 627 may retrieve availability information associated with the resources from a project data store. An availability model may be generated based on the availability information and the resources. The availability model may be provided to a client application to prompt the client application to render the availability model.

A component of the computing device 600, a communication device may be used by the computing device 600 to receive input and transmit output associated with the availability service 622. The program data 624 may also include, among other data, availability data 628, or the like, as described herein. The availability data 628 may include availability status associated with a resource across time periods, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide a dynamically response availability view. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

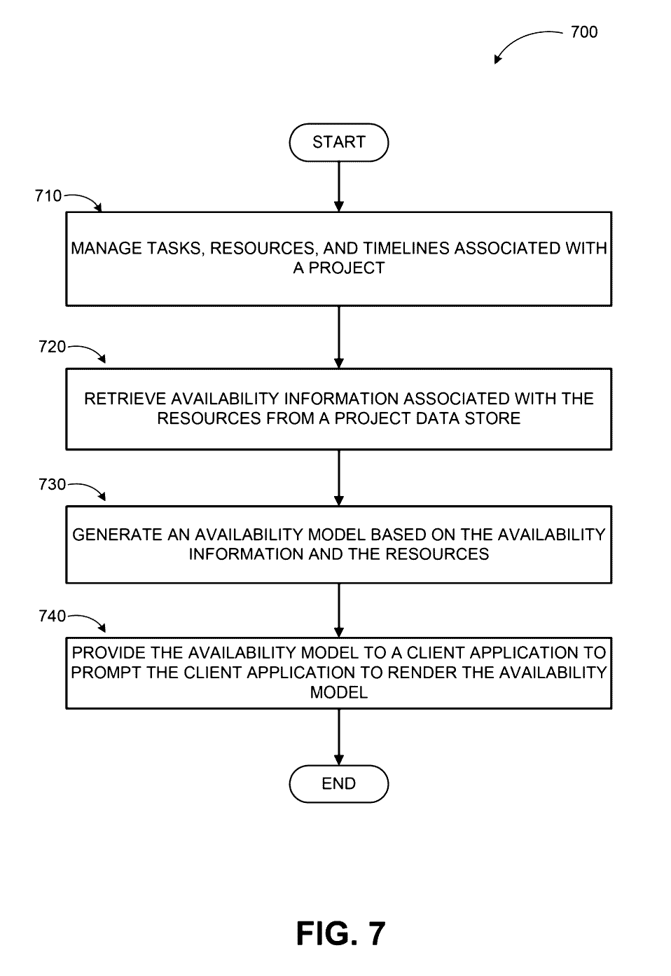

FIG. 7 is a logic flow diagram illustrating a process for providing a dynamically responsive availability view, according to embodiments. Process 700 may be implemented on a computing device, such as the computing device 600 or another system.

Process 700 begins with operation 710, where an availability service may manage tasks, resources, and a timeline associated with a project. The resources may include people, consumables, and/or other entities associated with the project. At operation 720, availability information associated with the resources may be retrieved from a project data store. The availability information may include availability status associated with a resource across a timeline of recurring time periods.

At operation 730, the availability service may generate an availability model based on the availability information and the resources. A chart of availability status may plotted to show a cross section of a collection of resources and recurring time periods of a timeline. At operation 740, the availability model may be provided to a client application to prompt the client application to render the availability model.

The operations included in process 700 are for illustration purposes. Providing a dynamically responsive availability view may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some examples, a computing device for providing a dynamically responsive availability view may be described. The computing device may include a communication device, a memory configured to store instructions associated with an availability service, and one or more processors coupled to the memory and the communication device. The one or more processors may execute the availability service in conjunction with the instructions stored in the memory. The availability service may include a management module and an availability module. The management module may be configured to manage tasks, resources, and a timeline associated with a project. The availability module may be configured to retrieve availability information associated with the resources from a project data store, generate an availability model based on the availability information and the resources, and provide the availability model to a client application to prompt the client application to render the availability model.

According to other examples, the availability module is further configured to generate the availability model from a collection of the resources, a timeline of the availability information, and a chart of availability status. The availability module is further configured to create the collection of the resources from a selection of the resources as selected by a stakeholder associated with the project. The availability module is further configured to construct the timeline with a recurring time period from a start date and an end date of the availability status, where the recurring time period includes one of an hour, a day, a week, a month, and a year. The availability module is further configured to create the chart of the availability status by plotting the availability status for each of the collection of the resources, where each of the collection of the resources are presented with a row of the availability status across the timeline.

According to further examples, the availability module is further configured to provide an access to the collection of the resources through a vertical scroll feature within the availability model, provide an access to the timeline of the availability information through a horizontal scroll feature within the availability model, and provide an access to the chart of the availability status through one or more of the horizontal scroll feature and the vertical scroll feature within the availability model. The availability module is further configured to present each of the availability status with a highlighting scheme to reflect variability associated with an individual availability status, where the individual availability status includes one of: a busy state and an available state associated with a resource.

According to further examples, the availability module is further configured to retrieve paged content for the availability information and resources from the project data store, restrict the paged content to a subset of the collection of the resources that are presently provided by the client application, and restrict the paged content to a subset of the availability status associated with the subset of the collection of resources, where the subset the availability status begins at a start date of the timeline and ends at an end date of the timeline as provided by the client application. The availability module is further configured to provide a staged cache of the collection of the resources, the timeline of the availability information, and the chart of the availability status within the availability model to prompt the client application to save calculated values and value aggregations associated the availability model, where the staged cache is provided to the client application to prevent the client application from re-querying the calculated values and the value aggregations. The availability module is further configured to process a first query and a second query associated with the availability model through a query pipeline, identify the first query as identical to the second query, discard the second query, process the first query to generate a first response, transmit the first response in response to the first query, and transmit the first response in response to the second query.

According to some examples a method executed on a computing device for providing a dynamically responsive availability view may be described. The method may include managing tasks, resources, and timelines associated with a project, retrieving availability information associated with the resources from a project data store, generating an availability model based on the availability information and the resources, where the availability model includes a collection of the resources, a timeline of the availability information, and a chart of availability status, and providing the availability model to a client application to prompt the client application to render the availability model.

According to other examples, the method may further include receiving a request for availability status details from the client application in response to an action on an availability status associated with a resource within the availability model, retrieving the availability status details from the project data store, and transmitting the availability status details to prompt the client application to render the availability status details. The availability status details may include the availability status presented in a recurring time period in relation to one or more of the project and one or more other projects associated with the resource. The method may further include receiving a request for resource details from the client application in response to an action on a resource within the availability model, retrieving the resource details from the project data store, and transmitting the resource details to prompt the client application to render the resource details. The resource details may include one or more of: identification information associated with the resource, one or more communication modalities available to contact the resource, a cost information associated with the resource, and a location information associated with the resource.

According to some examples, a computer-readable memory device with instructions stored thereon for providing a dynamically responsive availability view may be described. The instructions may include actions that are similar to the method described above.

According to some examples a means for providing a dynamically responsive availability view may be described. The means for providing a dynamically responsive availability view may include a means for managing tasks, resources, and a timeline associated with a project, a means for retrieving availability information associated with the resources from a project data store, a means for generating an availability model based on the availability information and the resources, and a means for providing the availability model to a client application to prompt the client application to render the availability model

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing a dynamically responsive availability view, the computing device comprising:
a communication device;
a memory configured to store instructions associated with an availability service;
one or more processors coupled to the memory and the communication device, the one or more processors executing the availability service in conjunction with the instructions stored in the memory, wherein the availability service includes:
a management module configured to:
manage tasks, resources, and a timeline associated with a project; and
an availability module configured to:
retrieve availability information associated with the resources from a project data store;
generate an availability model based on the availability information and the resources; and
provide the availability model to a client application to prompt the client application to render the availability model.

2. The computing device of claim 1, wherein the availability module is further configured to:
generate the availability model from a collection of the resources, a timeline of the availability information, and a chart of availability status.

3. The computing device of claim 2, wherein the availability module is further configured to:
create the collection of the resources from a selection of the resources as selected by a stakeholder associated with the project.

4. The computing device of claim 2, wherein the availability module is further configured to:
construct the timeline with a recurring time period from a start date and an end date of the availability status, wherein the recurring time period includes one of an hour, a day, a week, a month, and a year.

5. The computing device of claim 2, wherein the availability module is further configured to:
create the chart of the availability status by plotting the availability status for each of the collection of the resources, wherein each of the collection of the resources are presented with a row of the availability status across the timeline.

6. The computing device of claim 2, wherein the availability module is further configured to:
provide an access to the collection of the resources through a vertical scroll feature within the availability model;
provide an access to the timeline of the availability information through a horizontal scroll feature within the availability model; and
provide an access to the chart of the availability status through one or more of the horizontal scroll feature and the vertical scroll feature within the availability model.

7. The computing device of claim 2, wherein the availability module is further configured to:
present each of the availability status with a highlighting scheme to reflect variability associated with an individual availability status, wherein the individual availability status includes one of: a busy state and an available state associated with a resource.

8. The computing device of claim 2, wherein the availability module is further configured to:
retrieve paged content for the availability information and resources from the project data store.

9. The computing device of claim 8, wherein the availability module is further configured to:
restrict the paged content to a subset of the collection of the resources that are presently provided by the client application; and
restrict the paged content to a subset of the availability status associated with the subset of the collection of resources, wherein the subset the availability status begins at a start date of the timeline and ends at an end date of the timeline as provided by the client application.

10. The computing device of claim 2, wherein the availability module is further configured to:
provide a staged cache of the collection of the resources, the timeline of the availability information, and the chart of the availability status within the availability model to prompt the client application to save calculated values and value aggregations associated the availability model, wherein the staged cache is provided to the client application to prevent the client application from re-querying the calculated values and the value aggregations.

11. The computing device of claim 2, wherein the availability module is further configured to:
process a first query and a second query associated with the availability model through a query pipeline; and
identify the first query as identical to the second query.

12. The computing device of claim 11, wherein the availability module is further configured to:
discard the second query;
process the first query to generate a first response;
transmit the first response in response to the first query; and
transmit the first response in response to the second query.

13. A method executed on a computing device for providing a dynamically responsive availability view, the method comprising:
managing tasks, resources, and timelines associated with a project;
retrieving availability information associated with the resources from a project data store;
generating an availability model based on the availability information and the resources, wherein the availability model includes a collection of the resources, a timeline of the availability information, and a chart of availability status; and
providing the availability model to a client application to prompt the client application to render the availability model.

14. The method of claim 13, further comprising:
receiving a request for availability status details from the client application in response to an action on an availability status associated with a resource within the availability model;
retrieving the availability status details from the project data store; and
transmitting the availability status details to prompt the client application to render the availability status details.

15. The method of claim 14, wherein the availability status details include the availability status presented in a recurring time period in relation to one or more of the project and one or more other projects associated with the resource.

16. The method of claim 13, further comprising:
receiving a request for resource details from the client application in response to an action on a resource within the availability model;
retrieving the resource details from the project data store; and
transmitting the resource details to prompt the client application to render the resource details.

17. The method of claim 16, wherein the resource details include one or more of: identification information associated with the resource, one or more communication modalities available to contact the resource, a cost information associated with the resource, and a location information associated with the resource.

18. A computer-readable memory device with instructions stored thereon for providing a dynamically responsive availability view, the instructions comprising:
managing tasks, resources, and timelines associated with a project;
retrieving availability information associated with the resources from a project data store;
generating an availability model based on the availability information and the resources, wherein the availability model includes a collection of the resources, a timeline of the availability information, and a chart of availability status; and
providing the availability model to a client application to prompt the client application to render the availability model.

19. The computer-readable memory device of claim 18, wherein the instructions further comprise:
processing a first query and a second query associated with the availability model through a query pipeline;
identifying the first query as identical to the second query;
discarding the second query;
processing the first query to generate a first response;
transmitting the first response in response to the first query; and
transmitting the first response in response to the second query.

20. The computer-readable memory device of claim 18, wherein the instructions further comprise:
receiving a request for availability status details from the client application in response to an action on an availability status associated with a resource within the availability model, wherein the availability status details include the availability status presented in a recurring time period in relation to one or more of the project and one or more other projects associated with the resource;
retrieving the availability status details from the project data store; and
transmitting the availability status details to prompt the client application to render the availability status details.
